(19) United States
(12) Patent Application Publication
(10) Pub. No.: US 2025/0241283 A1
(43) Pub. Date: Jul. 31, 2025

(54) FISHING LURE RETRIEVER

(71) Applicant: Gregory Connelly, Sointula (CA)

(72) Inventor: Gregory Connelly, Sointula (CA)

(21) Appl. No.: 19/038,390

(22) Filed: Jan. 27, 2025

Related U.S. Application Data
(60) Provisional application No. 63/625,746, filed on Jan. 26, 2024.

(51) Int. Cl. A01K 97/24

(52) U.S. Cl. CPC A01K 97/24

(57) ABSTRACT

An apparatus and method for retrieving fishing lures wherein the apparatus comprises an elongate body having a passage therethrough extending between first and second ends, the elongate body comprising a base portion extending along a base plane and a tapered portion angularly oriented relative to the base plane to a first side thereof and a retaining ring extending to the first side of the base portion. The method comprises locating a fishing line within the passage of the elongate body, locating the fishing line within the retaining ring, permitting the elongate body to move down the fishing line to a stuck fishing lure at a distal end thereof and pulling the elongate body with retrieval line secured thereto.

### BACKGROUND

### 1. Technical Field

This disclosure relates generally to fishing and in particular to a method and apparatus for retrieving snagged fishing hooks and lures.

### 2. Description of Related Art

Fishing is a common and popular recreational activity. One of the most popular fishing methods is through the use of a fishing rod and line with a lure or hook at a distal end of the fishing line. One common difficulty encountered in such fishing activities is the propensity of the hook or lure to become snagged or hooked on an immovable or inanimate object under the water. Such snagged lures can be difficult to dislodge and may be frequently lost if a suitable retrieval method is employed.

### SUMMARY OF THE DISCLOSURE

According to a first embodiment of the present disclosure is an apparatus for retrieving fishing lures comprising an elongate body having a passage therethrough extending between first and second ends, the elongate body comprising a base portion extending along a base plane and a tapered portion angularly oriented relative to the base plane to a first side thereof and a retaining ring extending to the first side of the base portion.

The retaining ring may comprise a split ring. The split ring may overlap at a distal end with a gap between coils for introduction of a fishing line thereinto. The retaining ring may extend substantially orthogonally from the base portion. The retaining ring may be secured to a base member along first end of the elongate body. The retaining ring may comprise a continuous member extending perpendicularly from base portion and transitioning to a circular portion.

The elongate body may include a connector at the first end thereof configured to connect to a retrieval line. The connector may comprise a tab extending therefrom with a bore therethrough.

The base portion may comprise a semi-circular body forming a semi-circular opening through the elongate body. The base portion may comprise a base member and two side bodies extending thereform to the tapered proportion. The base portion may have a substantially circular cross section.

The tapered portion may be formed of a pair of side members converging to a distal end. The tapered portion may include an upward curvature towards the first side. The member forming the tapered portion may taper in cross section towards the second end of the elongate member. The tapered portion may be formed of a member having a substantially circular cross section.

According to a further embodiments of the present disclosure is a method for retrieving fishing lures comprising locating a fishing line within a passage of an elongate body extending between first and second ends, the elongate body comprising a base portion extending along a base plane and a tapered portion angularly oriented relative to the base plane to a first side thereof, locating the fishing line within a retaining ring extending to the first side of the base portion, permitting the elongate body to move down the fishing line to a stuck fishing lure at a distal end thereof and pulling the elongate body with retrieval line secured thereto.

Other aspects and features of the present disclosure will become apparent to those ordinarily skilled in the art upon review of the following description of specific embodiments in conjunction with the accompanying figures.

### BRIEF DESCRIPTION OF THE DRAWINGS

The accompanying drawings constitute part of the disclosure. Each drawing illustrates exemplary aspects wherein similar characters of reference denote corresponding parts in each view,

FIG. 1 is a perspective view of an apparatus for retrieving fishing lures according to a first embodiment of the present disclosure.

FIG. 2 is a perspective view of the apparatus of FIG. 2.

FIG. 3 is a side view off the apparatus of FIG. 2

FIG. 4 is a front end view of the apparatus of FIG. 2.

FIG. 5 is a cross sectional view of the apparatus of FIG. 2.

FIG. 6 is an exploded view of the apparatus of FIG. 2 according to a further embodiment.

### DETAILED DESCRIPTION

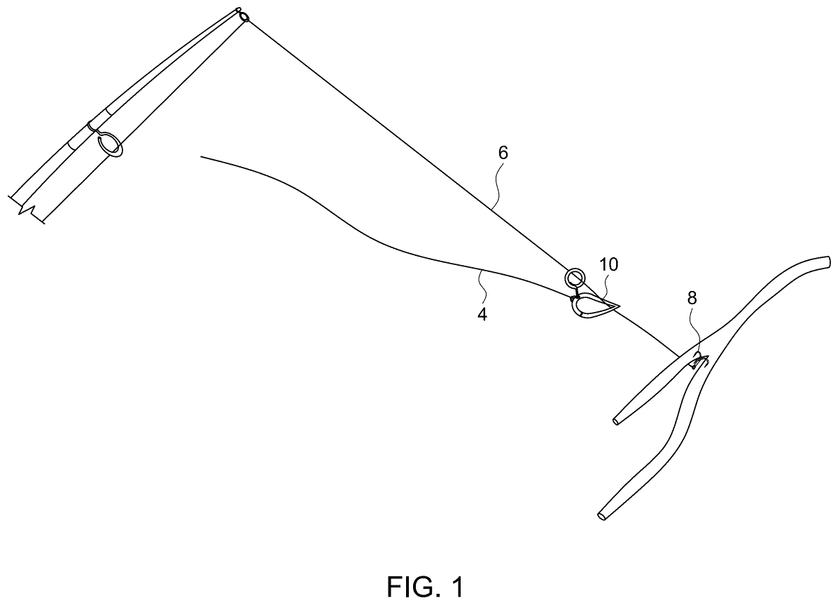

Referring to FIG. 1, an exemplary apparatus for retrieving a fishing lure 8 secured to the end of a fishing line 6 is illustrated generally at 10. The apparatus 10 comprises an elongate body having a ring 40 and a passage 30 therethrough a positioned to capture the fishing line 6 therein and thereby assist with removal of the hook 8 from an obstruction or the like.

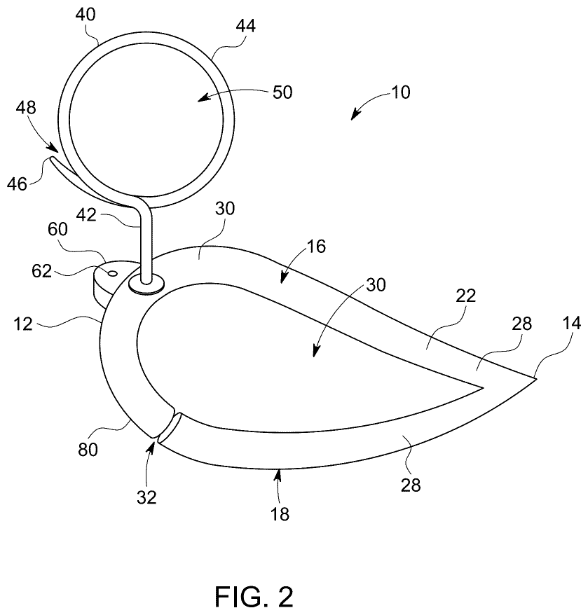

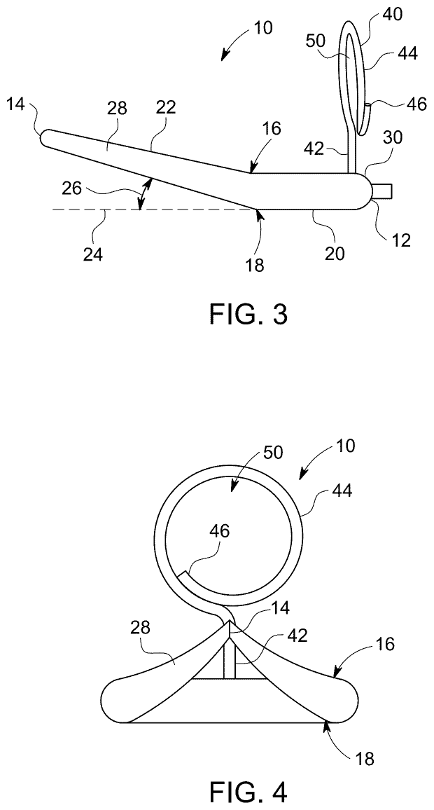

Turning now to FIG. 2, the apparatus 10 comprises an elongate body 11 extending between first and second ends, 12 and 14, respectively and having top and bottom surfaces, 16 and 18, respectively. The apparatus 10 may be formed of a base portion 20 extending from the first end and a tapered portion 22 extending from the second end. The base portion 20 extends along a base plane 24 wherein the tapered portion 22 is angled in a direction towards the top surface 16 by an angle generally indicated at 26 from the base plane as illustrated in FIG. 3. Optionally, the tapered portion 22 may curve upwards along a variable angle relative to the base plane 24.

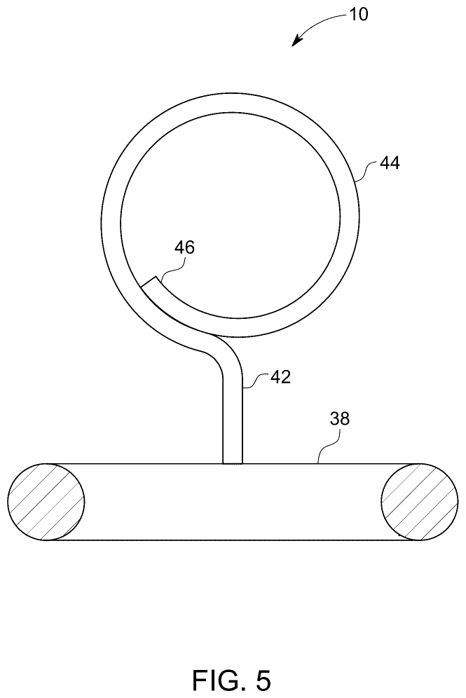

The apparatus 10 includes an opening passage 30 therethrough. The base portion 20 may be formed of side members and a rear member so as to form a wider opening passage 30 through the base portion. Optionally, the base portion 20 may be formed of a continuous arcuate member as illustrated. The tapered portion 22 may be formed of two side members 28 extending from the side members of the rear portion to a common point forming the second end 14 of the apparatus 10. Thus the opening passage 30 tapers to a narrower slot proximate to the second end 14. The apparatus 10 may be formed of smooth members so as to avoid snagging the fishing line 6 or other objects and in particular, by way of non-limiting example may include a circular cross section as illustrated in FIG. 5. As illustrated herein the side members 28 may taper in reduced diameter towards the second end 14. As illustrated in FIG. 2, the apparatus 10 may include a slot 32 extending therethrough so as to allow a fishing line 6 to be introduced into the opening passage 30. The slot 32 may be located through the base portion 20 and in particular may be located closer to the first end 12 than the second end 14, such as, by way of non-limiting example, approximately ¼ of the way therealong although it will be appreciated that the slot 32 may be located at any other location as well. Furthermore, the slot 32 may be arranged along an angle relative to the base portion, such as, by way of non-limiting example approximately angled forward at an angle of 45 degrees although other angles may also be useful. The elongate body may be formed of any suitable material operable in a wet environment including submerged. Further more the elongate body may be formed of a material having a density sufficiently high enough to provide a weight to the apparatus sufficient to pull down or otherwise dislodge a fishing lure when the apparatus is engaged thereon. In particular, it has been found that forming the elongate body of a metal, including, by way of non-limiting example, lead, steel, iron nickel, tin and alloys thereof has been useful. It has also been found that a weight of between 0.15 and 880 pounds (0.07 and 400 kg) has been useful.

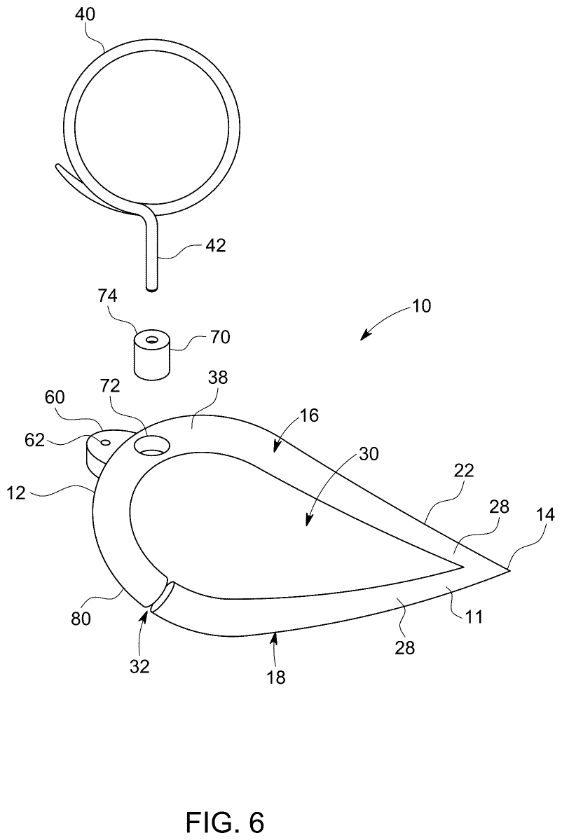

The apparatus includes a ring 40 positioned and sized to capture the fishing line 6 therethrough. As illustrated, the ring may comprise an upright member 42 extending to a substantially circular portion 44. The ring 40 may be secured to the base portion 20 of the apparatus at a rearmost portion 38 thereof and may extend substantially orthogonal relative thereto. The upright member 42 may extend from the rearmost portion 38 by a distance of 0.5 to inches (12 to 152 mm) so as to space the ring portion above the base portion by an appropriate distance. The ring portion 44 comprises a substantially circular bod extending to a distal end 46. The distal end 46 is positioned to lie adjacent to and offset from the overlapped portion of the ring portion 44 by a gap distance generally indicated at 48 so as to allow slidable introduction of the fishing line 6 thereinto. The ring portion 44 thus formed a ring passage 50 extending therethrough. The upright member 42 and ring portion 44 may be formed of a continuous member, such as by way of non-limiting example, metal or the like. Optionally, as illustrated in FIG. 6, the ring 40 may include an insert 70 operable to be imbedded or otherwise secured within the elongate body 11. The ring 40 may thereafter be securable within the insert 70. The insert may be secured within a bore 72 within the elongate body 11 through means of threading, adhesive or any other means as are commonly utilized. Furthermore, it will be appreciated that the ring 40 may be secured within a bore 74 in the insert through the use of threading or adhesives or the like. In particular it will be appreciated that the ring and the insert may be secured to each other and the elongate body through any means as are useful for providing such a connection without limitation. Optionally, the upright member 42 may pass through the elongate body 11 and be secured thereto with a fastener, such as by way of non-limiting example a nut or the like.

Optionally, the base portion 20 may include a tab 60 extending rearwardly thereform parallel to the base plane 24. The tab 60 may include a fastener, such as by way of non-limiting example, a bore 62 extending therethrough for securing to a line, rope or the like.

In operation, when a fishing lure is stuck the apparatus is placed located around the fishing line 6 with the line passing through the ring passage 50 and down through the body passage 30 as illustrated in FIG. 1. The apparatus is the slid down the line 6 until reaching the lure 8, at that point the line is directed into the narrowed tip of the passage 30 proximate to the second end 14. At such position the upward orientation of the tapered portion helps to allow the apparatus to approach the lure 8 and engage thereon. Thereafter, the narrowed second end 14 disengages the lure 8 from the object by surrounding the hooks for retrieval and pull back on the apparatus 10 by a retrieval line 4 secured to the tab 60.

While specific embodiments have been described and illustrated, such embodiments should be considered illustrative only and not as limiting the disclosure as construed in accordance with the accompanying claims.

What is claimed is:

1. An apparatus for retrieving fishing lures comprising:
an elongate body having a passage therethrough extending between first and second ends and having first and second sides, the elongate body comprising a base portion extending along a base plane and a tapered portion angularly oriented relative to the base plane to the first side; and
a retaining ring extending away from the first side of the base portion.

2. The apparatus of claim 1 wherein the retaining ring comprises a split ring.

3. The apparatus of claim 2 wherein the split ring overlaps itself at a distal end with a gap between coils for introduction of a fishing line thereinto.

4. The apparatus of claim 1 wherein the retaining ring extends substantially orthogonally from the base portion.

5. The apparatus of claim 1 wherein the retaining ring is secured to a base member proximate to the first end of the elongate body.

6. The apparatus of claim 1 wherein the retaining ring comprises a continuous member extending perpendicularly from base portion and transitioning to a circular portion.

7. The apparatus of claim 1 wherein the elongate body includes a connector at the first end thereof connectable to a retrieval line.

8. The apparatus of claim 7 wherein the connector comprises a tab extending therefrom with a bore therethrough.

9. The apparatus of claim 1 wherein the base portion comprises a semi-circular body forming a semi-circular opening through the elongate body.

10. The apparatus of claim 9 wherein the base portion comprises a base member and two side bodies extending thereform to the tapered proportion.

11. The apparatus of claim 10 wherein the tapered portion is formed of a pair of side taper members converging to a distal end.

12. The apparatus of claim 11 wherein the base portion has a substantially circular cross section.

13. The apparatus of claim 11 wherein the tapered portion includes an upward curvature towards the first side.

14. The apparatus of claim 13 wherein the tapered portion is formed of a member having a substantially circular cross section.

15. The apparatus of claim 10 wherein the member forming the tapered portion tapers in cross section towards the second end of the elongate member.

16. A method for retrieving fishing lures comprising:
locating a fishing line within a passage of an elongate body extending between first and second ends, the elongate body comprising a base portion extending along a base plane and a tapered portion angularly oriented relative to the base plane to a first side thereof;
locating the fishing line within a retaining ring extending to the first side of the base portion;
permitting the elongate body to move down the fishing line to a stuck fishing lure at a distal end thereof; and
pulling the elongate body with retrieval line secured thereto.
